(19) United States
(12) Patent Application Publication
(10) Pub. No.: US 2024/0216227 A1
(43) Pub. Date: Jul. 4, 2024

(54) Pacifier Training Device

(71) Applicant: Wendy McDaniel, Albuquerque, NM (US)

(72) Inventor: Wendy McDaniel, Albuquerque, NM (US)

(21) Appl. No.: 18/336,245

(22) Filed: Jun. 16, 2023

Related U.S. Application Data
(60) Provisional application No. 63/435,567, filed on Dec. 28, 2022.

(51) Int. Cl. A61J 17/00

(52) U.S. Cl. CPC A61J 17/1115; A61J 17/001

(57) ABSTRACT

A pacifier training device is provided. The device is designed to secure a pacifier in the mouth of an infant while the infant develops a suckling reflex. The device is primarily comprised of at least one support member with at least one strap. More specifically, the support member is worn around the head of an infant, wherein the strap connects to the support member. The strap also connects to a pacifier, such that the tension of the strap created by the support member and pacifier holds the pacifier into the mouth of the infant while the infant develops a suckling reflex.

### CROSS-REFERENCE TO RELATED APPLICATION

The present application claims priority to, and the benefit of, U.S. Provisional Application No. 63/435,567, which was filed on Dec. 28, 2022, and is incorporated herein by reference in its entirety.

### FIELD OF THE INVENTION

The present invention relates generally to the field of pacifiers. More specifically, the present invention relates to a pacifier training device designed to secure a pacifier in the mouth of an infant while the infant develops a suckling reflex. Accordingly, the present disclosure makes specific reference thereto. Nonetheless, it is to be appreciated that aspects of the present invention are also equally applicable to other like applications, devices, and methods of manufacture.

### BACKGROUND

Infants, especially those born prematurely, may be unable to hold a pacifier in their mouth due to a weak suckling reflex. Unfortunately, nurses caring for said babies may not have enough time to hold the pacifier in their mouth for 30 to 60 minutes, especially when there are numerous infants in the NICU. This is problematic for the infant as without a good suckling reflex, they may be unable to breastfeed or take a bottle.

Therefore, there exists a long-felt need in the art for a device that can be used to train an infant's suckling reflex. More specifically, there exists a long-felt need in the art for a pacifier training device that can be used on infants to train their suckling reflex. In addition, there exists a long-felt need in the art for a pacifier training device that can be used on infants to train their suckling reflex wherein the device does not require the involvement of a third party once applied to an infant.

The subject matter disclosed and claimed herein, in one embodiment thereof, comprises a pacifier training device. The device is primarily comprised of at least one support member with at least one strap. The device is intended to be used to hold a pacifier in the mouth of an infant to develop their suckling reflex. More specifically, the support member is worn around the head of an infant, wherein the strap connects to the support member. The strap also connects to a pacifier such that the tension of the strap created by the support member and pacifier holds the pacifier into the mouth of the infant while the infant develops a suckling reflex.

In this manner, the pacifier training device of the present invention accomplishes all the foregoing objectives and provides a device that can be used to train an infant's suckling reflex. While doing so, the device does not require the involvement of a third party once applied to an infant. As a result, the device is incredibly advantageous.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pacifier training device. The device is primarily comprised of at least one support member with at least one strap. The device is intended to be used to hold a pacifier in the mouth of an infant to develop their suckling reflex.

During use, the support member is placed around the head of an infant. The support member is comprised of at least one, but preferably two straps. A first end of a first strap attaches to the support member and is preferably made from an elastic material that provides a tension force to keep a pacifier attached to the strap in the mouth of an infant while the infant develops a suckling reflex. In one embodiment, the first end of the strap is attached to the support member through at least one opening of the support member to allow the strap to be pulled through the opening to make the strap shorter in length allowing for variable tension.

The second end of the strap may be tied around at least one opening of a body of a pacifier. In a different embodiment, the second end is comprised of at least one fastener such as, but not limited to, a clip, a clamp, an adhesive fastener, etc., to allow the second end to removably be attached to the pacifier. The pacifier may be any pacifier shape known in the art. The body of the pacifier has at least one sucking member that is preferably bulbous in shape.

The present invention is also comprised of a method of using the device. First, a device is provided comprised of at least one support member with at least one strap that attaches to at least one pacifier. More specifically, the second end of the strap may be tied to at least one opening in the pacifier. Then, the support member can be placed around the rear of the head of an infant (and in an embodiment with an adjustable strap, the strap can be pulled through the opening to adjust the length of the strap). Finally, the pacifier can be placed in the mouth of the infant, wherein the pacifier is secured in the infant's mouth via the tension from the strap.

Accordingly, the pacifier training device of the present invention is particularly advantageous as it provides a device that can be used to train an infant's suckling reflex. While doing so, the device does not require the involvement of a third party once applied to an infant. In this manner, the pacifier training device overcomes the limitations of existing methods of training an infant's suckling reflex that is known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a pacifier training device of the present invention in accordance with the disclosed architecture;

FIG. 2 illustrates a perspective view of one potential embodiment of a pacifier training device of the present invention in accordance with the disclosed architecture;

FIG. 3 illustrates a side view of one potential embodiment of a pacifier training device of the present invention while worn by an infant in accordance with the disclosed architecture; and

FIG. 4 illustrates a flowchart of a method of using one potential embodiment of a pacifier training device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to train an infant's suckling reflex. More specifically, there exists a long-felt need in the art for a pacifier training device that can be used on infants to train their suckling reflex. In addition, there exists a long-felt need in the art for a pacifier training device that can be used on infants to train their suckling reflex wherein the device does not require the involvement of a third party once applied to an infant.

The present invention, in one exemplary embodiment, is comprised of a pacifier training device primarily comprised of at least one support member with at least one strap. The device is intended to be used to hold a pacifier in the mouth of an infant to develop their suckling reflex. More specifically, the support member is placed around the head of an infant. The support member is comprised of at least one, but preferably two straps wherein a first end of a first strap attaches to the support member and is preferably made from an elastic material that provides a tension force to keep a pacifier attached to the strap in the mouth of an infant while the infant develops a suckling reflex. The first end of the strap may be attached to the support member through at least one opening of the support member to allow the strap to be pulled through the opening to make the strap shorter in length allowing for variable tension.

The second end of the strap may be tied around at least one opening of a body of a pacifier. In a different embodiment, the second end is comprised of at least one fastener such as, but not limited to, a clip, a clamp, an adhesive fastener, etc., to allow the second end to removably be attached to the pacifier. The pacifier may be any pacifier shape known in the art. The body of the pacifier has at least one sucking member that is preferably bulbous in shape.

The present invention is also comprised of a method of using the device. First, a device is provided comprised of at least one support member with at least one strap that attaches to at least one pacifier. More specifically, the second end of the strap may be tied to at least one opening in the pacifier. Then, the support member can be placed around the rear of the head of an infant (and in an embodiment with an adjustable strap, the strap can be pulled through the opening to adjust the length of the strap). Finally, the pacifier can be placed in the mouth of the infant, wherein the pacifier is secured in the infant's mouth via the tension from the strap.

Accordingly, the pacifier training device of the present invention is particularly advantageous as it provides a device that can be used to train an infant's suckling reflex. While doing so, the device does not require the involvement of a third party once applied to an infant. In this manner, the pacifier training device overcomes the limitations of existing methods of training an infant's suckling reflex that is known in the art.

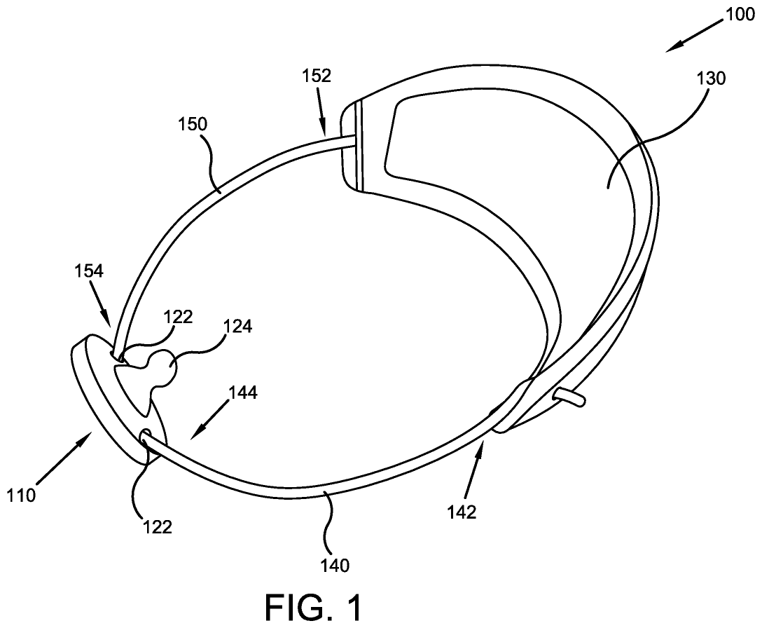

Referring initially to the drawings, FIG. 1 illustrates a perspective view of one potential embodiment of a pacifier training device 100 of the present invention in accordance with the disclosed architecture. The device 100 is primarily comprised of at least one support member 130 with at least one strap 140,150. The device 100 is intended to be used to hold a pacifier 110 in the mouth of an infant 10 to develop their suckling reflex.

The device 100 is comprised of a support member 130. During use, the support member 130 is placed around the head 12 of an infant. The support member is preferably made from a disposable fabric, breathable cloth, and/or foam material of any type known in the art.

The support member 130 is comprised of at least one, but preferably two straps 140, 150. A first end 142 of a first strap 140 attaches to the support member 130. The strap 140 is preferably made from an elastic material that provides a tension force to keep a pacifier 110 attached to the strap 140 in the mouth of an infant 10 while the infant 10 develops a suckling reflex. In one embodiment, the first end 142 of the strap 140 is attached to the support member through at least one opening 132 of the support member 130. As a result, the strap 140 can be pulled through the opening 132 to make the strap 140 shorter in length. This allows the tension created by the strap 140 to be adjusted as needed to fit infants 10 of different sizes.

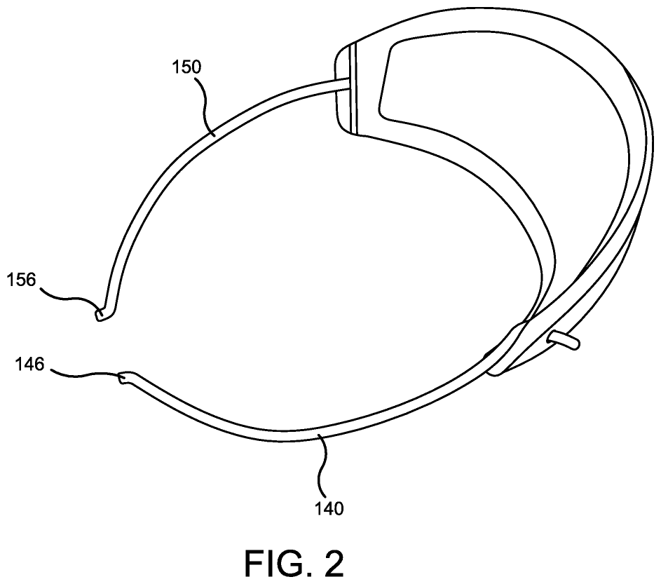

The second end 144 of the strap 140 may be tied around at least one opening 122 of a body 120 of a pacifier 110. In a different embodiment, the second end 144 is comprised of at least one fastener 146 such as, but not limited to, a clip, a clamp, an adhesive fastener, etc., to allow the second end 144 to removably attach to the pacifier 110, as seen in FIG. 2.

A first end 152 of a second strap 150 attaches to the support member 130. The strap 150 is preferably made from an elastic material that provides a tension force to keep a pacifier 110 attached to the strap 150 in the mouth of an infant 10 while the infant 10 develops a suckling reflex. In one embodiment, the first end 152 of the strap 150 is attached to the support member through at least one opening 132 of the support member 130. As a result, the strap 150 can be pulled through the opening 132 to make the strap 150 shorter in length. This allows the tension created by the strap 150 to be adjusted as needed to fit infants 10 of different sizes.

The second end 154 of the strap 150 may be tied around at least one opening 122 of a body 120 of a pacifier 110. In a different embodiment, the second end 154 is comprised of at least one fastener 156 such as, but not limited to, a clip, a clamp, an adhesive fastener, etc., to allow the second end 154 to removably attach to the pacifier 110.

The pacifier 110 may be any pacifier shape known in the art. The body 120 of the pacifier 110 has at least one sucking member 124 that is preferably bulbous in shape. In one embodiment, the second ends 144,154 of both straps 140,150 are fixedly attached to the pacifier 110.

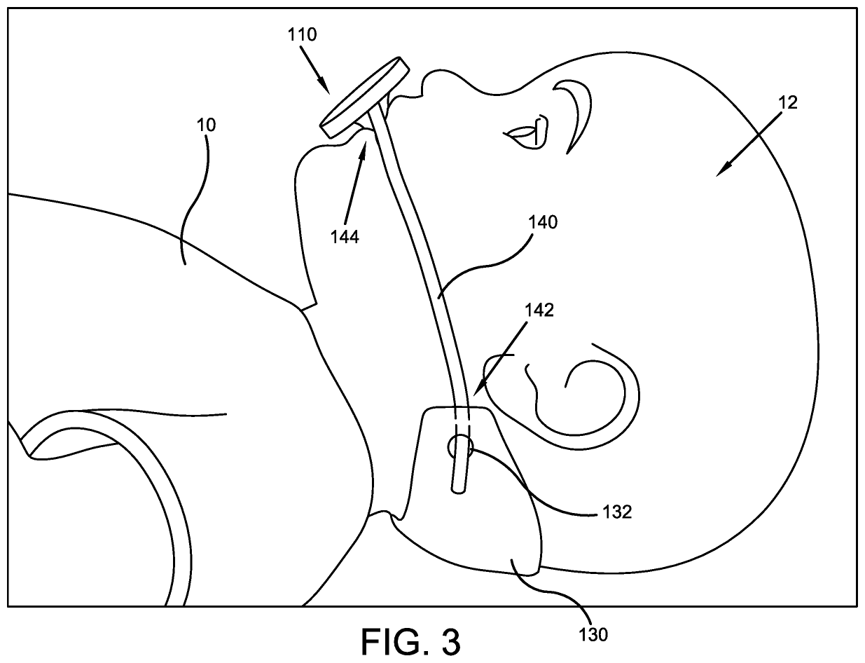

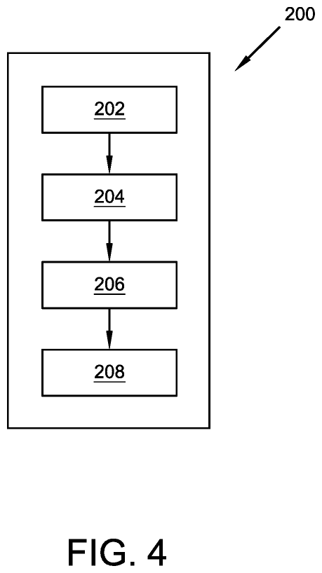

The present invention is also comprised of a method of using 200 the device 100, as seen in FIG. 4. First, a device 100 is provided comprised of at least one support member 130 with at least one strap 140,150 that attaches to at least one pacifier 110 [Step 202]. More specifically, the second end 144 of the strap 140,150 may be tied to at least one opening 122 in the pacifier 110 [Step 204]. Then, the support member 130 can be placed around the rear of the head 12 of an infant 10 (and in an embodiment with an adjustable strap 140,150, the strap 140,150 can be pulled through the opening 132 to adjust the length of the strap 140,150), as seen in FIG. 3 [Step 206]. Finally, the pacifier 110 can be placed in the mouth of the infant 10, wherein the pacifier 110 is secured in the infant's 10 mouth via the tension from the strap 140,150 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pacifier training device” and “device” are interchangeable and refer to the pacifier training device 100 of the present invention.

Notwithstanding the foregoing, the pacifier training device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pacifier training device 100 as shown in the FIGS. are for illustrative purposes only, and that many other sizes and shapes of the pacifier training device 100 are well within the scope of the present disclosure. Although the dimensions of the pacifier training device 100 are important design parameters for user convenience, the pacifier training device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pacifier training device comprising:
a support member;
a pacifier; and
a strap attached to the support member and to the pacifier.

2. The pacifier training device of claim 1, wherein the strap is comprised of an elastic material.

3. The pacifier training device of claim 1, wherein the support member is comprised of a cloth material.

4. The pacifier training device of claim 1, wherein the support member is comprised of a foam material.

5. The pacifier training device of claim 1, wherein the pacifier is comprised of a bulbous sucking member.

6. The pacifier training device of claim 1, wherein the strap is fixedly attached to the support member.

7. The pacifier training device of claim 1, wherein the strap is fixedly attached to the pacifier.

8. A pacifier training device comprising:
a support member comprised of a first opening and a second opening;
a pacifier;
a first strap comprised of a first end positioned through the first opening and a second end attached to the pacifier; and
a second strap comprised of a third end positioned through the first opening and a fourth end attached to the pacifier.

9. The pacifier training device of claim 8, wherein the first strap is comprised of an elastic material.

10. The pacifier training device of claim 8, wherein the second strap is comprised of an elastic material.

11. The pacifier training device of claim 8, wherein the pacifier is comprised of a third opening and a fourth opening.

12. The pacifier training device of claim 11, wherein the second end of the first strap attaches to the third opening.

13. The pacifier training device of claim 11, wherein the fourth end of the second strap attaches to the fourth opening.

14. The pacifier training device of claim 8, wherein the second end of the first strap is comprised of a first fastener.

15. The pacifier training device of claim 14, wherein the first fastener is comprised of a clip, a clamp, or an adhesive.

16. The pacifier training device of claim 8, wherein the fourth end of the second strap is comprised of a second fastener.

17. The pacifier training device of claim 16, wherein the second fastener is comprised of a clip, a clamp, or an adhesive.

18. A method of using a pacifier training device, the method comprising:
providing a pacifier training device comprised of a pacifier, a support member, and a strap that attaches to the pacifier and the support member;
attaching the strap to the pacifier;
placing the support member behind a head of an infant; and
placing a pacifier in a mouth of an infant.

19. The method of claim 18 further comprised of attaching the strap to the pacifier by tying the strap to the pacifier.

20. The method of claim 18 further comprised of pulling the strap through an opening of the support member to adjust a length of the strap.
